(19) United States
(12) Patent Application Publication
(10) Pub. No.: US 2022/0138418 A1
(43) Pub. Date: May 5, 2022

(54) RICH AND INTERACTIVE MECHANISM FOR PROVIDING WORD INFORMATION

(71) Applicant: Ryan Dawson, Pleasant Garden, NC (US)

(72) Inventor: Ryan Dawson, Pleasant Garden, NC (US)

(21) Appl. No.: 17/517,206

(22) Filed: Nov. 2, 2021

Related U.S. Application Data
(60) Provisional application No. 63/109,216, filed on Nov. 3, 2020.

(51) Int. Cl. G06F 40/247; G09B 5/02

(52) U.S. Cl. CPC G06F 40/247; G09B 5/02

(57) ABSTRACT

A graphical, rich, and interactive mechanism for exploring the forms and usage of a particular word. A word, identified as a lemma, can be displayed with its lexemes which cover multiple usages and tenses of the word. For each lexeme, collocates and synonyms are displayed, in a format that indicates which collocates and synonyms are used with the word most frequently. A word map contains the lemma, lexeme, synonyms, and collocates information for the word, and provides an interactive aspect by providing additional information when particular elements are icons of the word map are selected by the user.

### CROSS REFERENCE TO RELATED APPLICATIONS

The present application claims the priority benefit of U.S. provisional patent application 63/109,216, filed on Nov. 3, 2020, titled “RICH AND INTERACTIVE MECHANISM FOR PROVIDING WORD INFORMATION,” the disclosure of which is incorporated herein by reference.

### SUMMARY

Traditional dictionaries allow a user to look up a particular word and view a definition for that word. In some cases, additional versions of a word may also be seen within a typical dictionary format of listing information as text data down a page. What a dictionary does not indicate is more rich information for a particular word, such as how the word is used, words and sentences often use with the word, as well as an indication of which of the uses and words are most commonly used with the particular word.

The present technology provides a graphical, rich, and interactive mechanism for exploring the forms and usage of a particular word. A word, identified as a lemma, can be displayed with its lexemes which cover multiple usages and tenses of the word. For each lexeme, collocates and synonyms are displayed, in a format that indicates which collocates and synonyms are used with the word most frequently. A word map contains the lemma, lexeme, synonyms, and collocates information for the word, and provides an interactive aspect by providing additional information when particular elements are icons of the word map are selected by the user.

The graphical word map may include the word, one or more lexemes for the word, synonyms for the word and lexemes, and collocates. Each of the word, lexemes, synonyms, and collocates may be displayed within a graphical representation such as a shape or icon. The size of the graphical representation (e.g., an oval) may be directly related to the frequency of the element (e.g., frequency of use of the lexeme, synonym, and collocate).

The graphical representations in the graphical word map may be connected using one or more lines, bands, or other visual icons. In some instances, connecting lines (or other icon used to show a connection) may be generated to reflect aspects of corpus data associated with the connection between the two graphical representations. For example, a word and a collocate that are used more frequently together, such as the word “voyage” and collocate “maiden”, will be connected with a line that is thicker than a line that connects the word “voyage” and collocate “route

Once a graphical word map is generated, the map can be cached by the present system at a server or on a client device. Once cached, a graphical word map can be retrieved and displayed quicker than if the graphical word map were generated from scratch.

In embodiments, a method is disclosed for providing a graphical word map. The method begins with receiving a request for a word by an application on a machine. Lexeme data is retrieved for the word by the application. Collocate data can then be retrieved for the word by the application. Synonym data is retrieved for the word by the application. A frequency of use is determined for the retrieved lexeme by the application. The frequency of use is determined of each collocate by the application. The application on the machine can display a graphical word map for the requested word, the graphical word including graphical representations for the lexeme, collocate, and synonym data for the word.

### BRIEF DESCRIPTION OF THE DRAWINGS

FIG. 1A is a block diagram of an exemplary system for generating word data in graphical format.

FIG. 1B is a block diagram of a data store.

FIG. 2 is a block diagram of an exemplary server application.

FIG. 3 is an exemplary method for generating word data in graphical format.

FIG. 4 is an exemplary method for retrieving word data based on a received word.

FIG. 5 is an exemplary method for determining a relational score for collocates.

FIG. 6 is an exemplary for building a map of searched word and related word data.

FIG. 7A is an exemplary interface providing a word map.

FIG. 7B is another exemplary interface providing a word map.

FIG. 7C is an exemplary interface providing more detail for an adverb portion of a word map.

FIG. 7D is an exemplary interface providing more detail for an adverb collocates portion of a word map.

FIG. 8 is a block diagram of an exemplary system for implementing the present technology.

### DETAILED DESCRIPTION

The present technology provides a graphical, rich, and interactive mechanism for exploring the forms and usage of a particular word. A word, identified as a lemma, can be displayed with its lexemes which cover multiple usages and tenses of the word. For each lexeme, collocates and synonyms are displayed, in a format that indicates which collocates and synonyms are used with the word most frequently. A graphical word map contains the lemma, lexeme, synonyms, and collocates information for the word, and provides an interactive aspect by providing additional information when particular elements are icons of the word map are selected by the user.

The graphical word map may include the word, one or more lexemes for the word, synonyms for the word and lexemes, and collocates. Each of the word, lexemes, synonyms, and collocates may be displayed within a graphical representation such as a shape or icon. The size of the graphical representation (e.g., an oval) may be directly related to the frequency of the element (e.g., frequency of use of the lexeme, synonym, and collocate).

The graphical representations in the graphical word map may be connected using one or more lines, bands, or other visual icons. In some instances, connecting lines (or other icon used to show a connection) may be generated to reflect aspects of corpus data associated with the connection between the two graphical representations. For example, a word and a collocate that are used more frequently together, such as the word “voyage” and collocate “maiden”, will be connected with a line that is thicker than a line that connects the word “voyage” and collocate “route

Once a graphical word map is generated, the map can be cached by the present system at a server or on a client device. Once cached, a graphical word map can be retrieved and displayed quicker than if the graphical word map were generated from scratch.

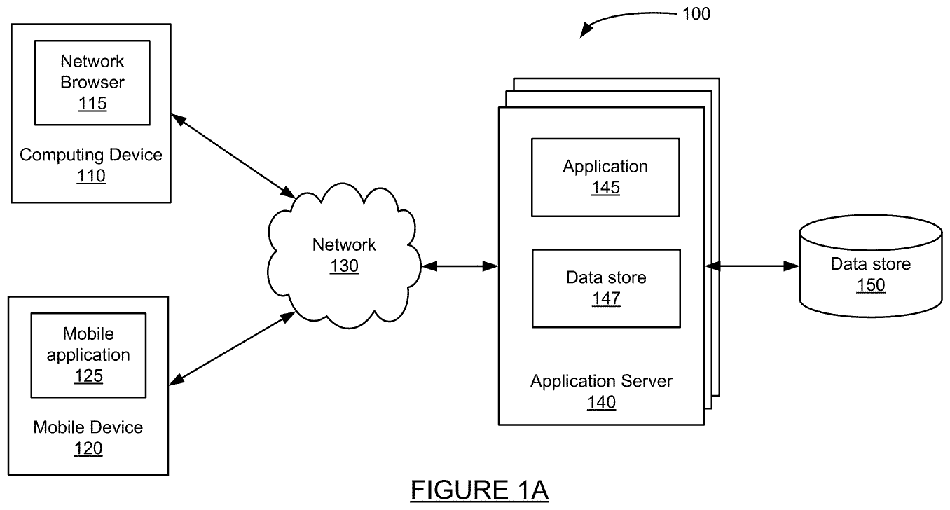

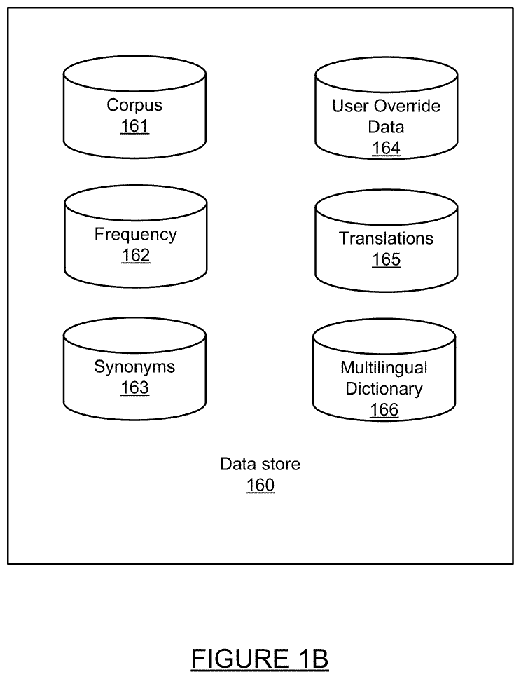

FIG. 1 is a block diagram of an exemplary system for generating word data in graphical format. System 100 of FIG. 1 includes computing device 110, mobile device 120, network 130, application server 140, and data storage 150.

Computing device 110 may include any device suitable to receive user input, process the input and output a graphical interface having a word map and to communicate with application server 140 over network 130, such as a desktop computer, smart phone, tablet computer, laptop, server, a workstation, or any other computing device. Computing device 110 may include network browser 115. Network browser 115 may be an application stored in memory of computing device 110, executed by one or more processors to receive, load, and output one or more content pages received from application 145, receive input through an input device computing device 110, and send data to application 145. In some instances, network browser 115 may be a web browser and provide web page content received over network 130, for example a webpage received from application server 140. The webpage content may be used to receive input and provide output according to functionality described herein. In some instances, the web browser may store one or more cached graphical word maps locally to the computing device or back to application server 140. When stored on computing device 110, the cached graphical word map may be stored as a cookie for the network browser or as a file in memory of the computing device.

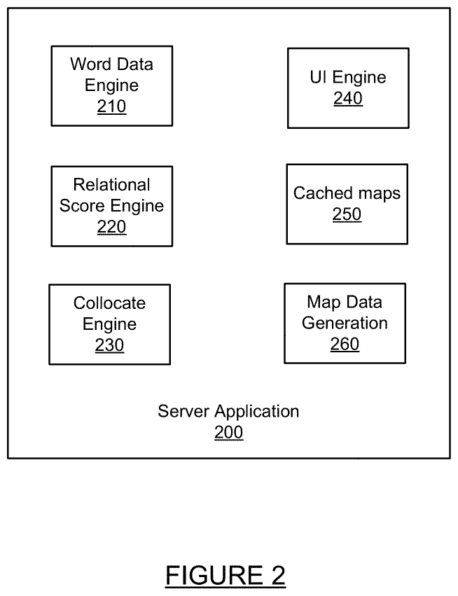

Mobile device 120 may include a smart phone, laptop computer, tablet computer, or any other computer that may be considered mobile in nature. Mobile device 120 may include mobile application 125. Mobile application 125 may communicate with application 145 on application server 140 to implement functionality described herein, including managing a display and interface of mobile device 120, providing a model engine, and video processing. In some instances, mobile application 125 may be implemented as a mobile application compatible with an IOS or android operating system. In some instances, the mobile application may store one or more cached graphical word maps locally to the mobile device or back to application server 140. When stored on mobile device 120, the cached graphical word map may be stored as a file in memory of the mobile device. Mobile application 125 is discussed in more detail with respect to FIG. 2.

Network 130 may be used to communicate data between one or more machines, including computing device 110, mobile device 120, application server 140, video storage 150, training data 160, and training video 170. Network 130 may be implemented by one or more public networks, private networks, an intranet, the Internet, a wireless or Wi-Fi network, a cellular network, or any other network suitable for communicating data.

Application server 140 may communicate with devices 110-120 as well as data stores 150-160. Application server 140 may include one or more machines that implement one or more physical or logical application servers. In some instances, application server 140 may include one or more machines that implement one or more physical or logical web servers (not illustrated in FIG. 1) that communicate with network 130 and one or more application servers.

Application 145 may reside in memory of one or more application servers 140 may be executed to provide functionality described herein. Application 145 may have software that, when executed by one or more processors, can receive user input, process the input, output graphical interface data, and communicate with devices 110-120. Application 145 is discussed in more detail below with respect to the block diagram of FIG. 2.

Datastore 147 may be implemented on one or more application servers 140, and may store data associated with one or more graphical word maps, user accounts, user lesson data, map configuration data, and other data. The data may be stored, accessed, modified, and deleted by application 145, network browser 115, and mobile application 125.

Datastore 150 may be implemented on one or more machines remote from application server 140, and may store data associated with one or more graphical word maps, user accounts, user lesson data, map configuration data, and other data. For example, data store 150 (and data store 147) may store word definition data, synonyms, collocates and other data. The data may be stored, accessed, modified, and deleted by application 145, network browser 115, and mobile application 125.

In some instances, datastores may be located on each of computing device 110 and mobile device 120, and each of data stores 110 and 120 may be similar in content and operation to data stores 147 and 150. More details for data store 147 and 150 are discussed with respect to the data store of FIG. 1B.

FIG. 1B is a block diagram of a data store. The data store 160 of FIG. 1B provides more details of an embodiment of data stores 147 and 150.

Datastore 160 includes corpus 161, frequency data 162, synonyms 163, user override data 164, translations 165, and multilingual dictionary data 166. Corpus data 161 can include corpus data containing but not limited to collocate data, mutual information data for a lemma and lexeme, directional measure data for a lexeme and lemma, and other data. Frequency data 162 can include word usage data and frequency of use data. In some instances, the frequency of use information may be obtained with the corpus information, from an open source system, for example. Synonym data may include synonyms for each word, lexeme, collocate, and so on.

User override data can include data associated with user changes to the graphical word map data. In some instances, users may correct a spelling, format, remove or editing in appropriate content, or other aspect of a particular word being displayed within a graphical word map. These changes may be made by users having permission to do so, such as a teacher in an instance of the system being used for educational purposes. When a word is changed, and override object or instance is created. The override object or instance data is stored at user override data 164. The overrides may take affect locally at the system at which they were changed, and under some conditions can be changed globally. For example, if the change is made by a minimum number of different users at different instances of the of the system, for example the same change is made 20 times, then the change can be pushed out globally. In another example, if an administrator with a permission to make a global change applies the local change to a global record of the word, the change will be made on a global level.

Translation data for one or more words or other portions of a graphical word map are stored at translations 165. The translation data may include translations for one or more words or phrases in one or more languages. In some instances, the translation data may be obtained from a third party service having a translation API.

A multilingual dictionary 166 may include definitions for words in a plurality of languages. The dictionary 166 can include text definitions, audio, video, images, and other data for the words in the dictionary. The text definitions, audio, video, images, and other data may be obtained from third party services over a network.

FIG. 2 is a block diagram of an exemplary server application. Server application 200 of FIG. 2 provides more detail for application 145 in the system of FIG. 1. Application 200 includes data engine 210, relational score engine 220, collocates engine 230, and user interface engine 240. Word data engine 210 may process user input received through an interface by retrieving word definition information, word lexeme data for a particular lemma, and word synonyms. Word collocates engine 230 may retrieve collocate data for one or more lemma and lexemes. User interface engine 240 may generate a user interface that displays a word lemma, lexeme, and collocates of lemmas and lexemes. User interface engine may also provide additional information based on user input, such as for example data regarding how a lemma, lexemes, synonym, or collocate may appear in a sentence.

Though an application with modules 210-240 is illustrated in the application 200 of FIG. 2, more or fewer modules may be implemented. Additionally, application 200 may be implemented as multiple applications with one or more modules each, which may include the modules illustrated in FIG. 2

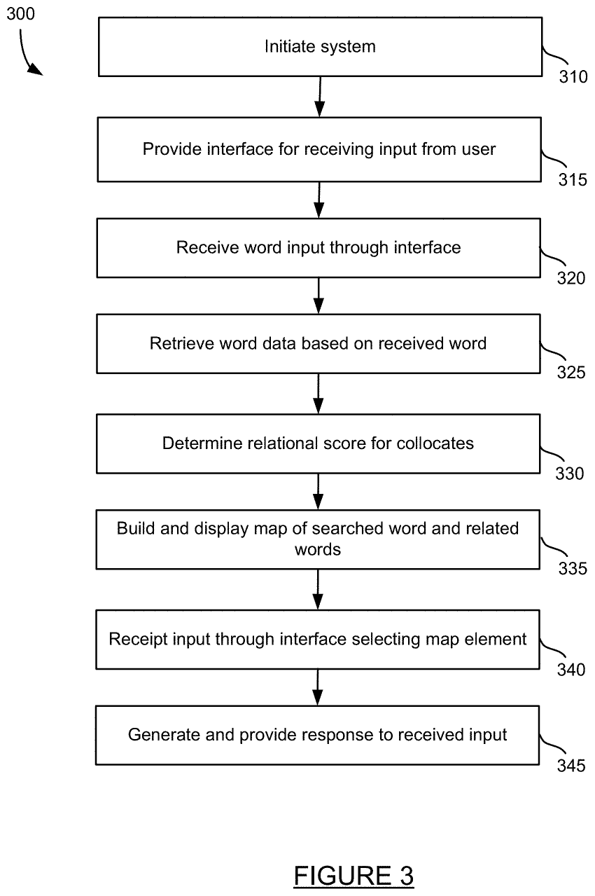

FIG. 3 is an exemplary method for generating word data in graphical format. The method of FIG. 3 begins with initiation of the system at step 310. Initiation may include booting up the word map generation software of the present system, providing an initial interface to a user, for example through a content page or a mobile application, accessing a user account, and other preliminary operations.

An interface for receiving input from a user is provided at step 315. The interface may include a text box, drop-down menu, or some other mechanism for receiving a user selection of a word from which to build a word map. The interface may be generated by application 145 and provided to a user through a network browser displayed con computing device 110 or mobile application 125. The interface may also be generated on a device local to a user, such as for example by a desktop application on a computer with the user or mobile application 125 on mobile device 120.

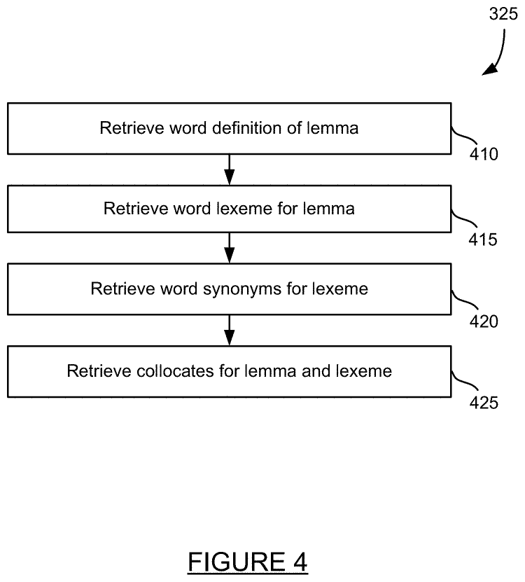

Word input may be received through the interface at step 320. The input may be received from the user via a microphone, a touch screen, physical or virtual alpha-numeric key input, a selection from a list of words in a dropdown menu of words, or other input. Word data based on the received word may be retrieved at step 325. The word data may include a definition, word lexeme, synonyms, and other data. More details for retrieving word data is discussed with respect to the method of FIG. 4.

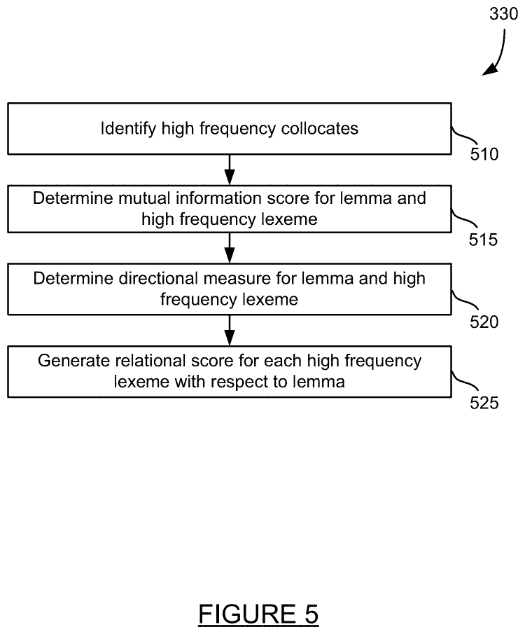

A relationship score is determined for collocates of the received word at step 330. The relationship score may include identifying high-frequency collocates used for a particular lexeme, mutual information scores for the collocates, and other data. More detail for determining a relationship score is discussed with respect to the method of FIG. 5.

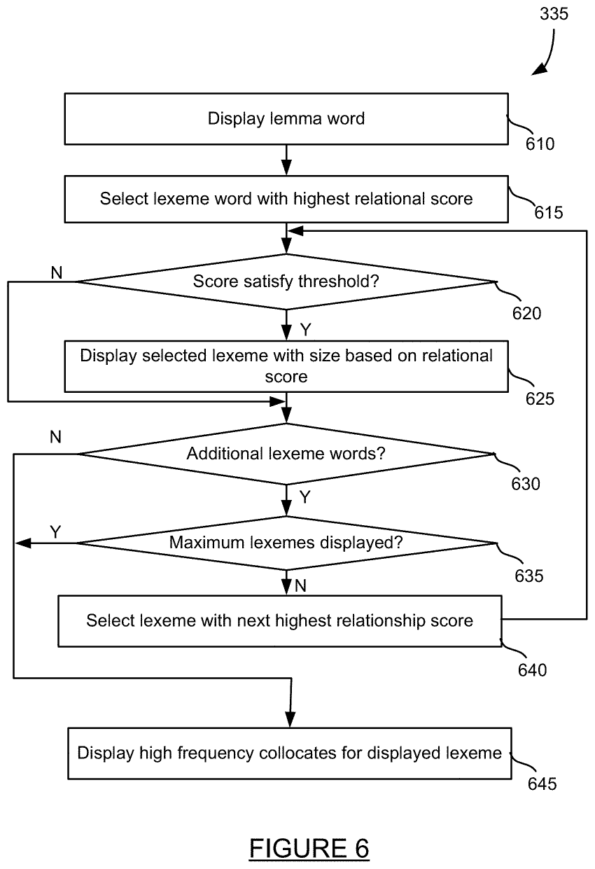

A word map for the received word is built at step 335. The map may include the word input by the user, as a lemma, lexemes for the word, synonyms for the lemma and lexeme, and collocates for the word, synonyms, and lexemes. The word map may be provided to a user through an interface, for example an interface provided through a network browser or mobile application. More detail for building a word map is discussed with respect to the method of FIG. 6.

Once the word map is generated, all or a portion of the map may be displayed through as part of a graphical word map interface. The graphical word map may include the word, one or more lexemes for the word, synonyms for the word and lexemes, and collocates. Each of the word, lexemes, synonyms, and collocates may be displayed within a graphical representation such as a shape or icon, including but not limited to a circle, square, oval, or other graphical representation. The size of the graphical representation, such as for example an oval, may be directly related to the frequency of the element (e.g., frequency of use of the lexeme, synonym, and collocate). For example, the higher the frequency of use value is, the larger the graphical representation in the graphical word map. The frequency may be the frequency of the use in general, for example in literature, or the frequency in usage with the word being displayed.

The graphical representations in the graphical word map may be connected using one or more lines, bands, or other visual icons. In some instances, connecting lines (or other icon used to show a connection) may be generated to reflect aspects of corpus data associated with the connection between the two graphical representations. For example, a word and a collocate that are used more frequently together, such as the word “voyage” and collocate “maiden”, will be connected with a line that is thicker than a line that connects the word “voyage” and collocate “route.” Additionally, if a collocate is typically used before a word, it will appear before, or to the left of, the word in the graphical word map. Similarly, if a collocate is typically used after a word, the collocate will appear after, or to the right of, the word in the graphical word map. If a collocate is used more often before but can be used after the word, the collocate will appear above and slightly to the left of the word in the graphical word map. If a collocate is used more often after but can be used before the word, the collocate will appear above and slightly to the right of the word in the graphical word map. If a collocate is used equally before and after the word, the collocate will appear centered above the word in the graphical word map.

Once a graphical word map is generated, the map can be cached by the present system. The cache of the graphical word map can be stored at a server by an application, at a client device by web browser code or content page code loaded by a content browser, or by a client application on a client device. In some instances, the cached map can be stored remotely at a data store by an application executing on a server. Once cached, a graphical word map can be retrieved and displayed quicker than if the graphical word map were generated from scratch. This can be very advantageous when multiple users may be retrieving the same graphical word map, for example in a classroom setting where students are loading a graphical word map as part of a lesson.

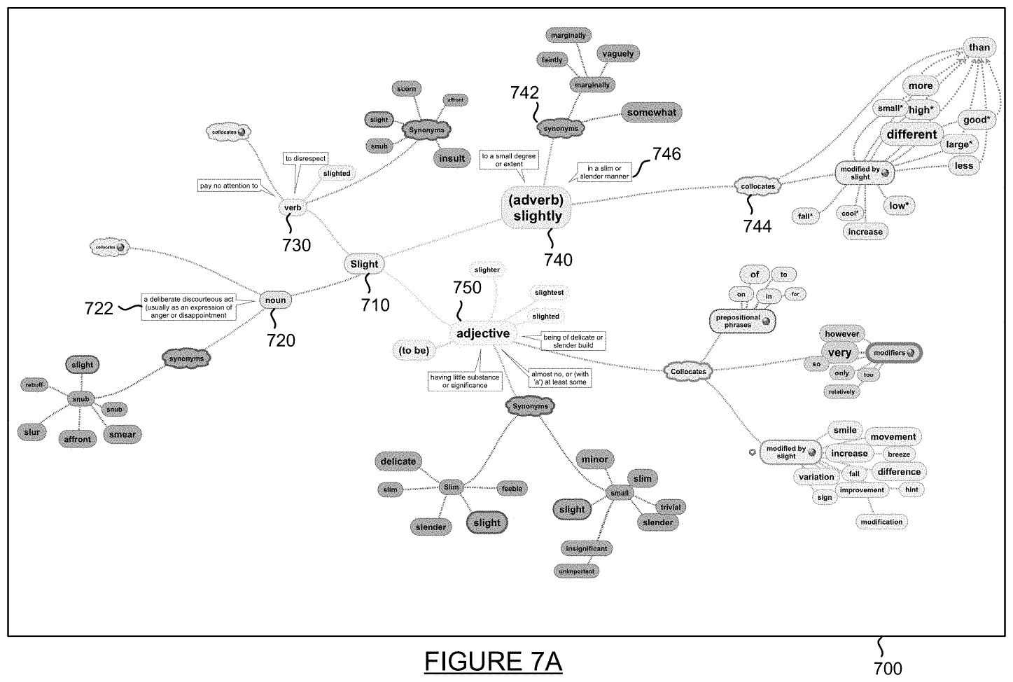

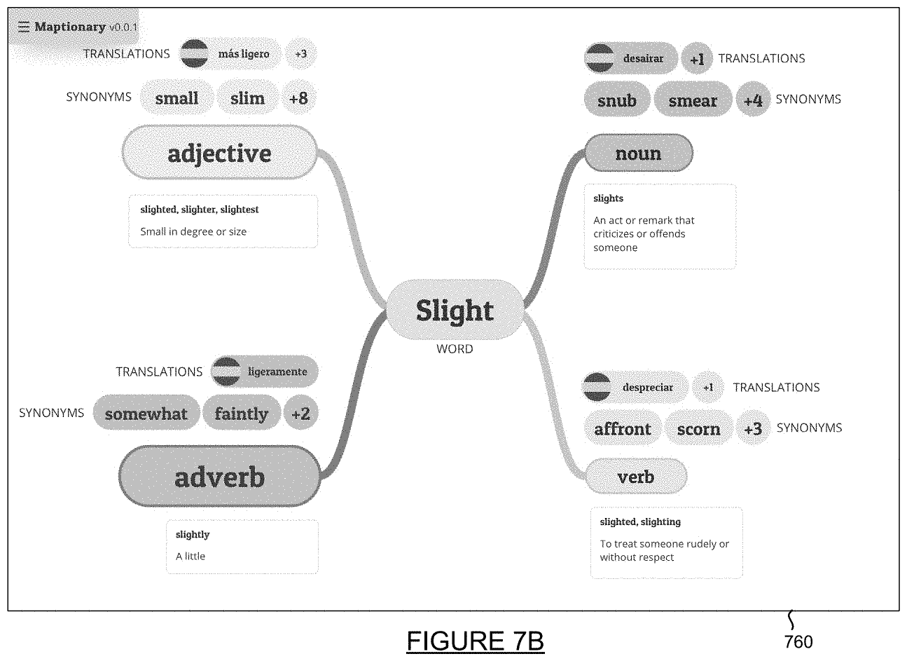

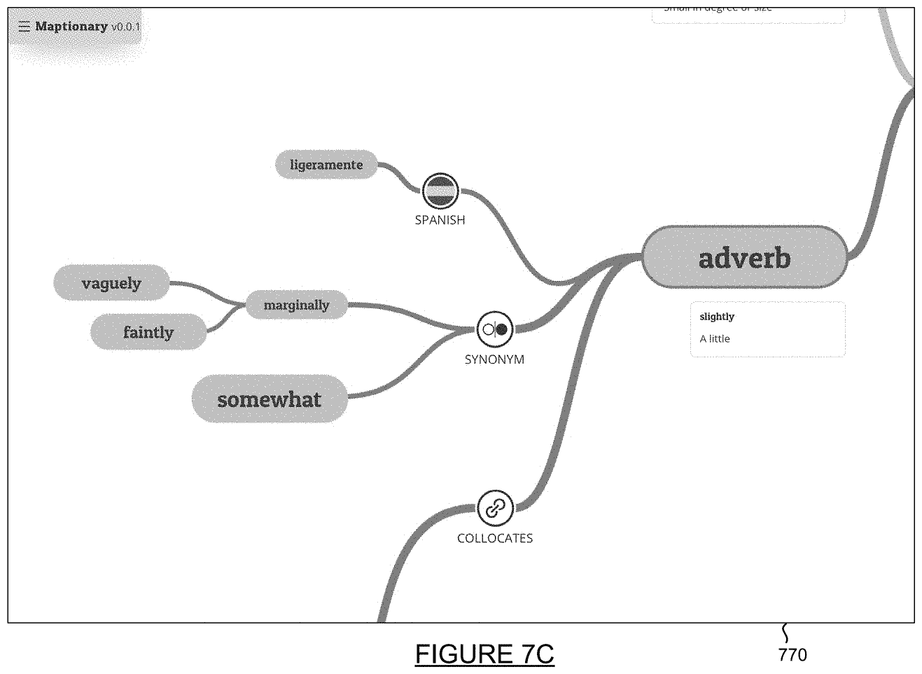

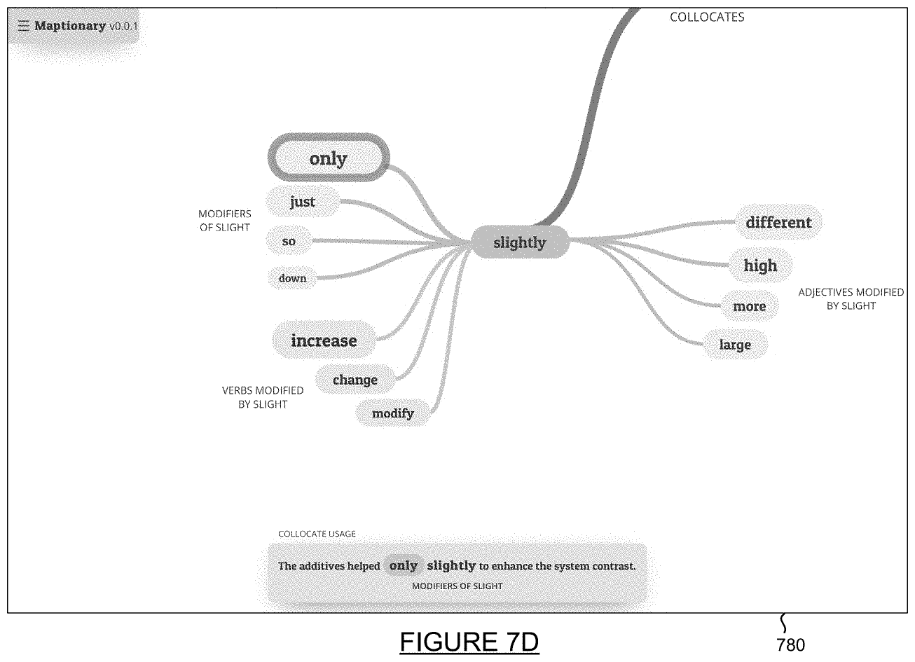

Input can be received through the interface selecting a word map element at step 340. The inputs may be a lexeme, a collocate, or another portion of the map. A response to the received input is generated at step 345. In some instances, the response may include a pop-up window that provides text, images, video, graphics, or other content regarding how a selected collocate, synonym, or lexeme may be used in a sentence. This additional information may help a user understand the particular word and the origins of the word. More detail for providing a response to a map a selection is discussed with respect to the word data map illustrated in FIG. 7A.

In some instances, the graphical word map may be used as part of a platform for education. For example, a student may read a story or a sentence, or be provided with one or more words, and may click on a word to learn more about. When an input is received to select a word, a graphical word map as described herein may be displayed for the student. The user may see the word, lexemes, synonyms, and collocates for the word, and upon receiving input from the user, the user can be returned to the previous interface to continue the lesson they were working on.

In some instances, the content incorporated into a graphical word map for a particular user may depend on the user's performance during a lesson. For example, if a user has a low level reading compression, the graphical word map may not include portions that would ordinarily be included. Hence, synonyms may not be included for a particular word if the student is having trouble with compression of the word itself.

FIG. 4 is an exemplary method for retrieving word data based on a received word. The method of FIG. 4 provides more detail for step 325 of the method of FIG. 3. First, a word definition for the lemma is retrieved at step 410. The lemma is the word received by the user through the user interface. The word definition data may be retrieved from a dictionary data store 150 in the system of FIG. 1. For example, a user may provide input of a word “slight.”

Word lexemes are retrieved for the lemma at step 415. The lexeme may be retrieved from one or more sets of corpus data 160 as illustrated in the system of FIG. 1. Lexemes may include different tenses for the lemma, different forms such as nouns, verbs, adverbs and adjectives, and other related forms of the lemma. For example, as shown in the word map of FIG. 7A, for the lemma “slight,”, lexemes include a noun, verb, adjective, and adverb of “slightly.”

Word synonyms may be retrieved for each lexeme at step 420. In addition to retrieving synonyms, collocates may be retrieved for the lemma and the lexemes for the lemma at step 425. The collocates may include words that are commonly used with the particular lexeme or lemma. In some instances, use of a particular lexeme in a sentence may also be retrieved by the present system. The lemma, lexeme, synonyms, collocates, and other data may be displayed in a word map for the word received as input from the user. An example of a word map based on a user input “slight” is a FIG. 7A.

FIG. 5 is an exemplary method for determining a relational score for collocates. The method of FIG. 5 provides more detail for step 330 the method of FIG. 3. First, high-frequency collocates are identified at step 510. In some instances, a group of collocates may be retrieved from corpus data from a data store remote from the application preparing the word map. The retrieved collocates may include ranking data for their frequency of use. In some instances, different instances of collocates can be retrieved and analyzed to determine which collocates occur most frequently within a corpus.

A mutual information score for lemma and each high-frequency lexeme is a tremendous step 515. The mutual information score may be generated based on any of several useful information algorithm techniques, and may indicate which lexeme most closely relate to the lemma. A directional measure for the lemma and the high-frequency lexemes are determined at step 520. The directional measure is a mechanism for determining how often a particular lexeme is used in place of a lemma. A relational score may then be generated for each high-frequency lexeme with respect to the lemma at step 525. The relational score may be based on the mutual information score and the directional measure for each lexeme. In some instances, the score and measure may both be normalized and averaged to determine the relational score. In some instances, either the mutual information score or directional measure, or both, can be weighted somewhat to determine a relational score. In some instances, other factors and data, such as administrator preference, can be used in generating the relational score for a particular lexeme.

FIG. 6 is an exemplary method for building a map of searched word and related word data. The method of FIG. 6 provides more detail for step 335 the method of FIG. 3. First, the lemma word is displayed within a user interface at step 610. A selected lexeme word having the highest relational score is then selected at step 615.

A determination is made as to whether the relational score for the selected lexeme satisfies a threshold at step 620. The threshold may be some value that ensures selected lexemes are related to the particular lemma. If a score does not satisfy the threshold, the method of FIG. 6 continues to step 630. If the score does satisfy the threshold, an icon for the selected lexeme is positioned within the graphical word map and with a size proportional on the relational score at step 625. For example, if the selected lexeme has a relational score that is higher than 90 (with a maximum score assumed of 100 and), the size of the lexeme may be large. If the selected lexeme has a relational score having a range between 70-80, the selected lexeme may be displayed as an icon having a smaller size than that in the highest range. If the selected lexeme has a relational score between 70 and 65 (wherein, for example, 65 is the threshold for displaying a lexeme), the selected lexeme may be displayed as an icon that is smallest in size in comparison to the other lexemes. The method of FIG. 6 then continues to step 630.

A determination is made as to whether any additional lexeme words exist at step 630. If additional lexeme words exist, a determination is made as to whether the maximum number of lexemes has already been displayed in the word map at step 635. In some instances, an administrator may specify a maximum number of lexemes to display within the word map, for example to prevent a word map from becoming too cluttered or unwieldy. If the maximum number of lexemes has been displayed, the method of FIG. 6 continues to step 645. If the maximum number of lexemes has not been displayed, a lexeme with the next highest relationship score is selected at step 640 and the method continues to step 620.

If no additional lexeme words exist at step 630, high-frequency collocates and other data is displayed for one or more lexemes at step 645. The collocates may be prepositional phrases, something modified by the lemma, modifiers, and other collocates.

The collocates, and other data may be displayed with a visual indication of a connection to a particular lexeme or other word component. For example, collocates for a particular lexeme may be displayed with a line between the collocate and the lexeme associated with the collocate. Additionally, the collocate itself may be displayed as an icon with text within the icon. The icon may be a shape, such as a circle or square, and may be a color, shading, or other indication that the collocate has some association with another word. For example, in the interface of FIG. 7A, collocates for the lexeme ‘adjective’ 750 have three colors—light purple for prepositional phrases, goldenrod yellow for modifiers, and light blue for those “modified by slight.” Other icons for the lemma, lexemes, and other word components may similarly be displayed with graphical icons having text or other content, and in which the icons are visually connected to other related words and have colors indicating associations or groupings.

FIG. 7A is an exemplary interface providing a word map. Upon receiving input from a user for a particular word to generate a word map from, that word becomes the lemma. In FIG. 7A, the lemma 710 is the word “slight.” The word has for lexemes: a noun version 720, a verb version 730, an adverb version “slightly” 740, and an adjective version 750. As shown in the interface of FIG. 7A, the adverb icon 740 has the largest size, because it has the most synonyms and collocates, and appears most frequently in the corpus. The adjective icon 750 has the next largest size, and the noun and verb icons 720 and 730, respectively, have the smallest size within the word map.

Adverb icon 740 is visually connected to synonym icons 742 and collocate icon 744. Synonyms icon 742 is linked to several synonyms for the adverb “slightly.”. The synonyms include “somewhat” and “marginally.” Marginally in turn is connected to three additional synonyms of faintly, marginally, and vaguely.

Collocate icon 744 is visually connected to an icon for the word “than” and an icon for “modified by a slight.”. The “modified by slight” is visually connected to several words, including fall, cool, low, and increase. The “modified by slight” icon is also visually connected to words of small, different, high, large, and less. Several these words are also connected to then, which is connected to collocates icon 744.

Collocates and synonyms are provided for several of the lexemes in the word map 700. For example, adjective 750 is connected to collocates and synonyms, verb 730 is connected to synonyms and an icon for collocates which is not connected to any particular words, and noun 720 is connected to synonyms and collocates.

The word map of interface 700 may provide information in addition to the lemma, lexeme, collocate, and synonym information. If a particular collocate is selected by the user, for example by hovering a cursor over the collocate icon, or placing the cursor over the icon and receiving a right-click selection of a mouse, or some other input, additional data may be provided with respect to the lexeme (or other word or icon within the word map of interface 700). For example, for noun 720, selecting the noun icon 720 results in a pop-up 722 that reads “a deliberate discourteous act (usually as an expression of anger or disappointment).” Similarly, upon receiving an input selecting the lexeme for “slightly,” a pop-up may appear that provides text of “in a slim or slender manner.” In some instances, one or more lexemes may have multiple data or information provided based on the number of clicks, or other input provided to the particular lexeme icon. For example, adjective icon 750 may display any of three pop-up windows upon being selected, as illustrated in the interface of 700 of FIG. 7A. In some instances, translations—for example of synonyms—may also be provided by the present system through an interface. The translations may be offered as a parallel grouping, a subset, or via a pop-up window, box, or graphical element in response to user input such as a mouse-over or click.

FIG. 7B is another exemplary interface providing a word map 760. The word map of FIG. 7B provides color keyed content for a particular word, such as an adjective, noun, adverb and verb. For each adjective, noun, adverb and verb, the word map provides synonym words and definitions, as well as translations.

FIG. 7C is an exemplary interface 770 providing more detail for an adverb portion of a word map. The interface 770 provides synonyms, a translation, and a collocate node for an adverb.

FIG. 7D is an exemplary interface 780 providing more detail for an adverb collocates portion of a word map. Interface 780 provides collocates that are modifiers, are modified by, and adjectives that are modified by “slight.”

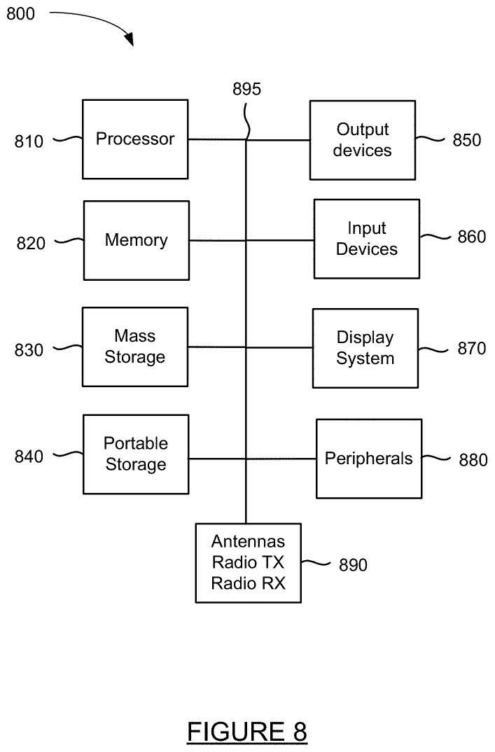

FIG. 8 is a block diagram of an exemplary system for implementing the present technology. System 800 of FIG. 8 may be implemented in the contexts of the likes of computing device 110, mobile device 120, application server 140, and data stores 150-160.

The computing system 800 of FIG. 8 includes one or more processors 810 and memory 820. Main memory 820 stores, in part, instructions and data for execution by processor 810. Main memory 810 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable or remote storage device 840, and display system 870 may be connected via one or more input/output (I/O) buses.

Mass storage device 830, which may be implemented with a magnetic disk drive, an optical disk drive, a flash drive, or other storage type, is a non-volatile storage device for storing data and instructions for use by processor unit 810. Mass storage device 830 can store the system software for implementing embodiments of the present technology for purposes of loading that software into main memory 820.

Portable storage device 840 operates in conjunction with a portable non-volatile storage medium, such as a compact disk, USB drive, external hard drive, digital video disk, magnetic disk, flash storage, etc. to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device, such as a mouse, a trackball, stylus, cursor direction keys, a touch screen display for receiving touch input, a microphone for receiving audio input, and one or more cameras for capturing gesture input. Additionally, the system 800 as shown in FIG. 8 includes output devices 850. Examples of suitable output devices include speakers, printers, network interfaces, image projectors, and monitors.

Display system 870 may include a liquid crystal display (LCD), an LED display, or other suitable display device. Display system 870 receives textual and graphical information, and processes the information for output to the display device. In some instances, a display within display system 870 may also operate as an input device as discussed with respect to input devices 860.

Peripherals 880 may include any type of computer support device to add additional functionality to the computer system. For example, peripheral device(s) 880 may include a modem or a router, speaker, or other peripheral.

When implementing a mobile device such as smart phone or tablet computer, the computer system 800 of FIG. 8 may include one or more antennas, radios, and other circuitry 890 for communicating over wireless signals, such as for example communication using Wi-Fi, cellular, or other wireless signals.

The components contained in the computer system 800 of FIG. 8 can include a personal computer, hand held computing device, telephone, mobile computing device, workstation, server, minicomputer, mainframe computer, tablet computer, smart device (e.g., an Internet of Things or IoT device), or any other computing device. The computer can also include different bus configurations, networked platforms, multi-processor platforms, etc. Various operating systems can be used including Unix, Linux, Windows, Apple OS, Android, and other suitable operating systems, including mobile versions.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for providing a graphical word map, comprising:
receiving a request for a word by an application on a machine;
retrieving lexeme data for the word by the application;
retrieving collocate data for the word by the application;
retrieving synonym data for the word by the application;
determining a frequency of use for the retrieved lexeme by the application;
determining the frequency of use of each collocate by the application; and
displaying, by the application on the machine, a graphical word map for the requested word, the graphical word including graphical representations for the lexeme, collocate, and synonym data for the word.

2. The method of claim 1, further comprising determining a mutual information score for lemma and high frequency lexeme.

3. The method of claim 1, further comprising determining a directional measure for lemma and high frequency lexeme.

4. The method of claim 1, further comprising generating a relational score for each high frequency lexeme with respect to the lemma, wherein the retrieve lexeme is displayed if the relational score satisfies a frequency threshold.

5. The method of claim 1, wherein collocates are retrieved and displayed for two or more of the word, lexeme, and synonym.

6. The method of claim 5, wherein the size of the graphical representation for the collocate is proportional to the frequency of use of the collocate.

7. The method of claim 1, wherein the length of a line connecting two elements of the graphical word map is based on frequency of use.

8. The method of claim 1, wherein the graphical word map is used as part of an educational software system.

9. The method of claim 1, wherein at least a portion of a graphical word map is removed from the display based on a user.

10. The method of claim 1, further comprising:
creating a cached copy of the displayed graphical word map at the machine;
retrieving a subsequent request for a graphical word map for the word associated with the cached copy; and
providing the cached copy in response to the subsequent request.

11. A non-transitory computer readable storage medium having embodied thereon a program, the program being executable by a processor to perform a method for providing a graphical word map, the method comprising:
receiving a request for a word by an application on a machine;
retrieving lexeme data for the word by the application;
retrieving collocate data for the word by the application;
retrieving synonym data for the word by the application;
determining a frequency of use for the retrieved lexeme by the application;
determining the frequency of use of each collocate by the application; and
displaying, by the application on the machine, a graphical word map for the requested word, the graphical word including graphical representations for the lexeme, collocate, and synonym data for the word.

12. A system for a graphical word map, comprising
one more processors;
memory; and
a plurality of modules stored in memory and executable by the one or more processors to receive a request for a word by an application on a machine, retrieve lexeme data for the word by the application, retrieve collocate data for the word by the application, retrieve synonym data for the word by the application, determine a frequency of use for the retrieved lexeme by the application, determine the frequency of use of each collocate by the application, and display, by the application on the machine, a graphical word map for the requested word, the graphical word including graphical representations for the lexeme, collocate, and synonym data for the word.
